(19) United States
(12) Patent Application Publication
(10) Pub. No.: US 2002/0134464 A1
(43) Pub. Date: Sep. 26, 2002

(54) Guard device for a standing circular saw

(75) Inventor: Wilfried Altendorf, Minden (DE)

Correspondence Address: ALTERA LAW GROUP, LLC, 6500 CITY WEST PARKWAY, SUITE 100, MINNEAPOLIS, MN, 55344-7704, US

(73) Assignee: ALTENDORF GMBH & CO. KG, Minden (DE)

(21) Appl. No.: 10/084,041

(22) Filed: Feb. 27, 2002

(30) Foreign Application Priority Data
Feb. 27, 2001 (DE) 20103373.9

(51) Int. Cl. B27G 19/02

(52) U.S. Cl. 144/251.1

(57) ABSTRACT

In accordance with the invention a guard device for a standing circular saw, in particular for a bench circular saw, comprising a guard hood which is fixed removably and adjustably in respect of height to an arm fixed to the circular saw machine and which at least partially encloses a saw blade with a hollow space having an opening at the underside of the guard hood and which has at least one suction removal opening for saw waste, which suction removal opening communicates with said hollow space of the guard hood and leads into a suction removal conduit is characterized in that the guide path formed from the hollow space through the suction removal opening into the suction removal conduit has only changes in direction >90°. In a further aspect of the invention such a guard device is characterized in that the guard hood is fixed to the arm in positively locking relationship and can be moved out of the positively locking engagement horizontally in the plane of the saw blade.

The present invention concerns a guard device for a standing circular saw, as set forth in the classifying portions of claim 1 and claim 17.

Stationary or standing circular saw machines are known and widely used in particular in the wood-working industry. Their saw blade which rotates at high speed represents a major danger for an operator who is working with the machine and who generally has to feed a workpiece by hand. Therefore, guard hood devices are known to protect the operator—and are prescribed in various countries in various safety standards—, which at least partially enclose a saw blade with a hollow space or cavity having an opening at the underside of the guard hood. Such guard hoods ensure that the operator does not by mistake put his hand into the rotating saw blade, in particular from above. However, guard hoods which are adjustable in respect of height are also known, which clear a cutting region of the saw blade only when a workpiece is moved theretowards. In addition, removable and replaceable hoods are known, which on the one hand permit replacement and repair and which on the other hand permit the use of guard hoods of varying internal contour, for example for inclined cuts with saw blades which are set in an inclined position. Suction removal openings are also known, which lead from the interior of the hood into a suction removal conduit, for carrying away sawdust and saw chips.

The known guard hood devices however are all capable of being improved in terms of their reliability and handling. Thus, known devices with suction removal units have a tendency to become clogged with dust and chips, which adversely affects the functioning thereof. Changing the guard hoods on known devices by means of screw fixings is a complicated procedure and, in the case of known guard hoods which are adjustable in respect of height and which are fixed to the machine by way of a long arm, the adjusting mechanism is also ‘shaky’ by virtue of the arm which projects by a substantial distance, and that excessive mobility on the one hand involves an unreliability factor while on the other hand it entails the risk of the hood colliding with the rotating saw blade.

In comparison the object of the present invention is to provide a guard hood device for a standing or stationary circular saw, the functions of which are improved in regard to reliability and handling.

In accordance with the invention that object is attained by a guard device having the features of claim 1 and by a guard device having the features of claim 17. Preferred configurations of the invention are set forth in the appendant claims.

In accordance with the invention a guard device for a standing circular saw—in particular for a bench circular saw but also for example for a circular saw machine with substantially vertical workpiece feed for wall mounting—has a guard hood with a hollow space with an opening for at least partially enclosing the saw blade of the circular saw machine. The guard hood is fixed to an arm which in turn is fixed to the circular saw machine and the guard hood is adjustable in respect of height thereon and is in particular removable for replacement purposes. In addition a suction removal opening for saw chips and sawtooth communicates with the hollow space in the hood and leads into a suction removal conduit through which the dust and chips can be removed. In accordance with the invention a guide path formed from the hollow space of the hood through the suction removal opening into the suction removal conduit is such that it only has changes in direction with an obtuse angle, that is to say greater than 90° and preferably greater than 120°. It preferably has radii of curvature of not less than 20 cm and particularly preferably not less than 50 cm.

That guide path which is as continuous as possible and which in accordance with the invention can carry the air which has been sucked away and which carries chips and dust provides for low levels of turbulence and, particularly when the guide paths have a preferred, smooth-walled, non-fissured wall contour, affords an extreme reduction in regions with flow shadows and so-called ‘dead water’ areas. That avoids deposits and the consequential need for cleaning of the suction removal arrangements.

So that the suction air can be guided in as aerodynamically favourable condition as possible, it is possible to integrate into the guide path and in particular in the region of the suction removal opening at least one air guide bar which there can additionally also perform the function of a stiffening rib.

In order to ensure suction removal with the highest possible level of efficiency, the hollow space in the guard hood encloses the saw blade as closely and as flush as possible—naturally however still with a certain minimum spacing in order to ensure reliably collision-free rotation of the saw blade beneath the guard hood. So that this enclosure which is as close as possible is ensured both when the saw blade is in a straight position and also when the saw blade is an angled position for inclined cuts—but also in order to be able to replace the guard hood for repair operations—, the guard hood described hereinbefore is replaceable, and more specifically in accordance with a further aspect of the invention it is for that purpose fixed to the arm in positively locking relationship and can be moved horizontally out of the positively locking engagement in the plane of the saw blade.

That direction of movement corresponds to the feed movement of the workpiece and, for an operator making use of the device, it is logical, understandable and therefore also particularly safe.

Preferably, the guard hood can be moved out of the condition of positively locking engagement in the direction of the region of the circular saw, out of which the workpieces are passed—where consequently the operator using the circular saw is standing when using the circular saw in the usual fashion.

The positively locking engagement is preferably afforded by a dovetail profile but also for example push-in pins or projections or other profiles of undercut configuration with suitable locking means are in accordance with the invention.

The positively locking engagement is preferably secured by a releasable securing safety lock which also involves positively locking engagement, in order not to risk the hood being removed by mistake—or even coming away of its own accord for example due to vibration. The securing lock can be embodied in accordance with the invention by a for example spring-biased locking pawl or by a securing safety screw which engages as a lock member into a groove.

For the purposes of particularly easy handling (moreover not only in terms of interchangeability but also for the purposes of heightwise adjustment) the guard hood can preferably have an integrated handle in a front edge which is directed in the direction of the workpiece feed to the circular saw. The safety lock is then preferably also arranged there in the region of the handle, for the sake of simplicity of operation.

These features according to the invention of the positively locking connection which is releasable for replacement purposes can be combined in accordance with the invention with the above-described features according to the invention of the design configuration of the suction guide path, which is advantageous in terms of its curvature.

It is possible to combine with both groups of features individually or jointly in accordance with the invention moreover mounting for the guard hood which is adjustable in respect of height in a linear guide means on the arm, the guard hood preferably being ball-mounted. In order to compensate for its inherent weight, the guard hood can be biased upwardly by means of a spring in the linear guide means, in which respect that biasing effect can be adjustable and/or can be braked by a brake which brakes the movement of the guard hood in the linear guide means. The brake is preferably frictionally engageable, with possibly adjustable frictional engagement.

Preferably the guard hood substantially completely covers over initially the cutting region of the saw blade—which for example in the case of a bench circular saw projects up out of the bench top. In order now to produce an inclined cut on a workpiece which is moved to the circular saw, the guard hood preferably has a guide profile which co-operates with the fed workpiece to lift the guard hood to such a degree that the workpiece reaches therebeneath the cutting edge of the saw blade and is cut there. In order to advantageously assist with that upward pressing movement (that is to say in a substantially vertical direction) by virtue of the substantially horizontal feed movement of the workpiece, the linear guide means is preferably tilted out of the vertical, more specifically in the plane of the saw blade away from the region of the workpiece feed. That produces a motion component for the guard hood in addition to the upward direction also in the direction of the workpiece feed and consequently makes that actuation procedure easier. Preferably the guide profile is in the form of a roller which with an axis of rotation parallel to the axis of rotation of the saw blade forms the front lower edge of the underside opening of the hood.

In accordance with the invention heightwise adjustment of the guard hood can also be actuated by motor means. The motor then preferably has a control means with a sensor which monitors the region of the workpiece feed in front of the saw blade. That sensor can detect the presence of an object, in particular a workpiece, and thereupon give the control means a signal for appropriate actuation of the motor. In particular if it is preferably in the form of a video camera the sensor can also distinguish a workpiece from for example a part of the body of the operator using the saw and, upon detection of the latter, for the safety thereof, can in fact cause the control means to precisely not actuate the motorised lifting movement of the guard hood.

The present invention is described hereinafter with reference to the accompanying drawings in which:

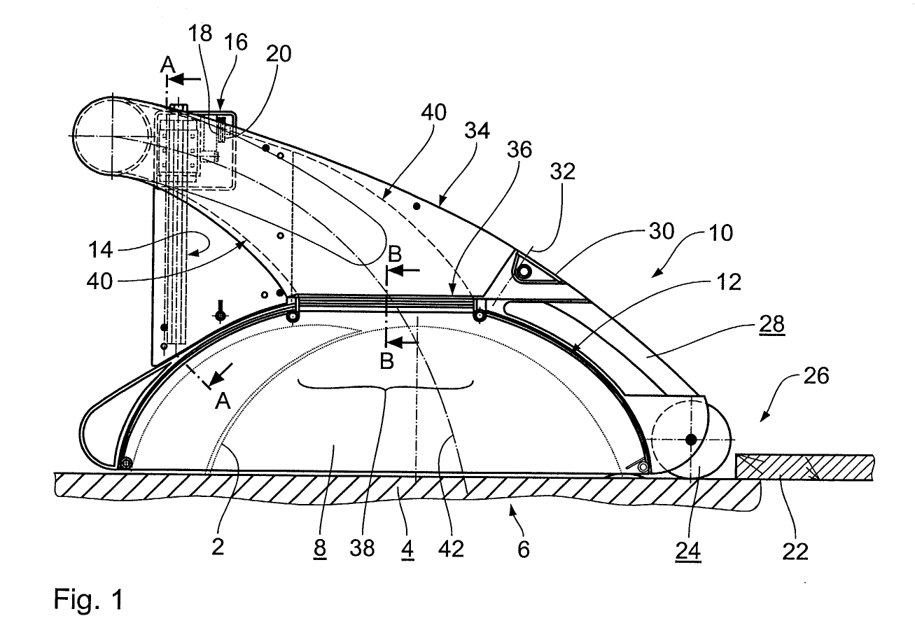

FIG. 1 shows a side view of a guard device according to the invention,

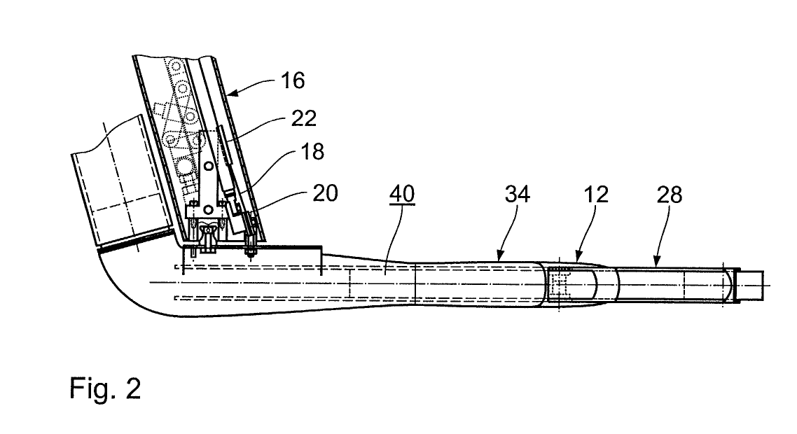

FIG. 2 shows a plan view of the guard device of FIG. 1,

FIG. 3 shows a front view of the guard device of FIGS. 1 and 2 in section taken along line A-A, and

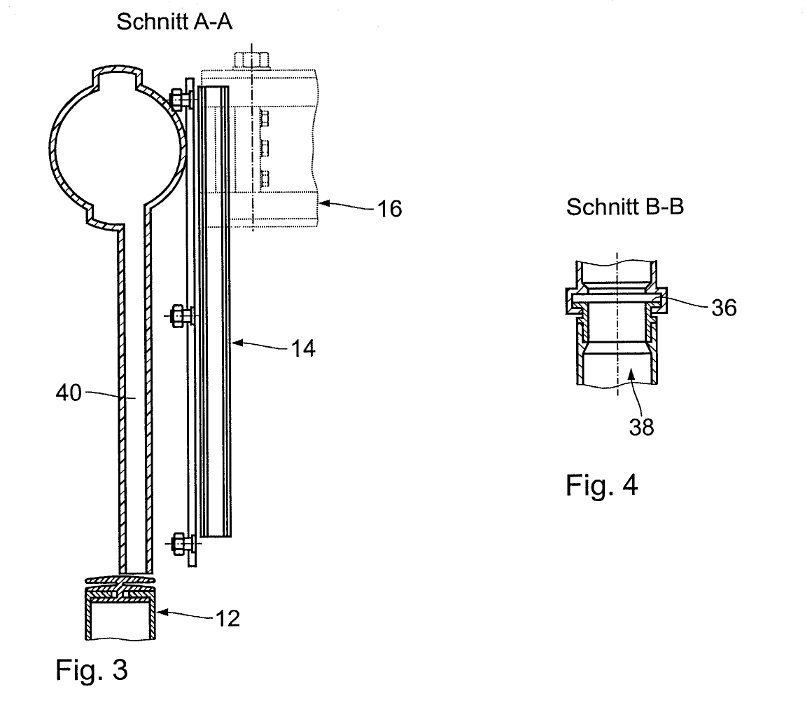

FIG. 4 shows a detail from FIG. 1 in section along line B-B.

FIG. 1 shows in stylised form a saw blade 2 which projects up out of the top side of a bench 4 of a bench-type circular saw 6. A guard device 10 with a guard hood 12 is lowered over the cutting region 8 of the saw blade 2, the cutting region 8 being in the form of a segment of a circle. For that purpose, the guard hood 12 is mounted adjustably in respect of height by way of a linear guide 14 on a substantially horizontal arm 16. To compensate for the inherent weight of the guard hood 12 and the components connected thereto, they are biased upwardly by way of a cable 18 and by way of a roller 20, by means of a spring 22. A workpiece 22 which is moved to the saw blade 2 on the bench 4 (from the right in FIG. 1) co-operates there with a guide profile which is in the form of a roller 24 to urge upwardly the hood 12 which is mounted in the linear guide 14 so that the workpiece 22 can pass under the hood 12 which is then urged upwardly, to the saw blade 2. In order to facilitate that effect the linear guide 14 can alternatively be tilted away from the region of the workpiece feed 26, out of the illustrated vertical (that is to say towards the left in FIG. 1).

In order also to lift the hood 12 by manual actuation—but also in order to replace it (description in that respect follows)—the hood 12 has an integrated handle 28 in a front edge of the guard hood 12, which is directed in the direction of the workpiece feed 26. It is possible to see above the handle 28 a securing safety lock 30—which also alternatively can be in the form of a securing screw about an axis illustrated in the form of a line of action at 32. When the securing lock 30 is actuated it pulls a pin upwardly along the axis 32 and thus enables a degree of freedom of a positively locking connection between the hood 12 and a carrier support 34 which adjoins the hood 12 at the upper side. That permits the hood 12 to be pulled off the carrier support 34 horizontally (towards the right in FIG. 1). In order not to collide with the saw blade 2 the hood 12 for that purpose can be lifted off the saw blade 2 by means of the linear guide 14. That withdrawal movement is made possible by a dovetail-shaped (that is to say positively locking) connecting rail or bar 36 at the apex of the hood 12 (see also FIG. 4).

FIG. 4 also shows in particular that the dovetail profile is arranged around a suction removal opening 38 at the apex of the guard hood 12. The suction removal opening 38 communicates with a suction removal conduit 40 in the carrier support 34. FIG. 1 shows the continuous guide path which therein is inclined towards the left (indicated by the centre line 42 with changes in direction of not less than 120°, measured between the tangents (not shown) at the beginning and at the end of the line 42).

1. A guard device for a standing circular saw, in particular for a bench circular saw, comprising a guard hood which is fixed removably and adjustably in respect of height to an arm fixed to the circular saw machine and which at least partially encloses a saw blade with a hollow space having an opening at the underside of the guard hood and which has at least one suction removal opening for saw waste, which suction removal opening communicates with said hollow space of the guard hood and leads into a suction removal conduit, characterized in that the guide path formed from the hollow space through the suction removal opening into the suction removal conduit has only changes in direction >90°.

2. A device according to claim 1 characterized in that at least one air guide plate is integrated at least in the region of the suction removal opening.

3. A device according to one of the preceding claims characterized in that the guard hood is supported on the arm adjustably in respect of height in a linear guide.

4. A device according to claim 3 characterized in that the guard hood is biased upwardly by means of a spring in the linear guide to compensate for its inherent weight.

5. A device according to one of claims 3 and 4 characterized by a brake which brakes the movement of the guard hood in the linear guide.

6. A device according to claim 5 characterized in that the brake is adjustable and involves frictional engagement.

7. A device according to one of claims 3 to 6 characterized in that in the region of the workpiece feed in front of the saw blade the guard hood has a guide profile which urges the guard hood upwardly by a fed workpiece, and that the linear guide is tilted out of the vertical away from the region of the workpiece feed in the plane of the saw blade.

8. A device according to claim 7 characterized in that the guide profile is formed by a roller which forms the front lower edge of the underside opening of the hood.

9. A device according to one of the preceding claims characterized by a motor which drives the heightwise adjustment of the guard hood.

10. A device according to claim 9 characterized by control of the motor with a sensor which monitors the region of the workpiece feed in front of the saw blade and which delivers a signal to the control means upon the presence of an object in said region.

11. A device according to claim 10 characterized in that the sensor is a video camera.

12. A device according to one of the preceding claims characterized in that the guard hood is fixed to the arm in positively locking relationship and can be moved out of the positively locking engagement horizontally in the plane of the saw blade.

13. A device according to claim 12 characterized in that the guard hood can be moved out of the positively locking engagement horizontally in the plane of the saw blade in the direction of the workpiece feed to the circular saw.

14. A device according to one of claims 12 and 13 characterized in that the positively locking engagement is formed by a dovetail profile.

15. A device according to one of claims 12 to 14 characterized in that the positively locking engagement has a positively locking, releasable securing lock.

16. A device according to one of the preceding claims characterized in that a handle is integrated in a front edge of the guard hood, which is directed in the direction of the workpiece feed to the circular saw.

17. A guard device for a standing circular saw, in particular for a bench circular saw, comprising a guard hood which is fixed removably and adjustably in respect of height to an arm fixed to the circular saw machine and which at least partially encloses a saw blade with a hollow space having an opening at the underside of the guard hood and which has at least one suction removal opening for saw waste, which suction removal opening communicates with said hollow space of the guard hood and leads into a suction removal conduit, characterized in that guard hood is fixed to the arm in positively locking relationship and can be moved out of the positively locking engagement horizontally in the plane of the saw blade.

18. A device according to claim 17 characterized in that the guard hood can be moved out of the positively locking engagement horizontally in the plane of the saw blade in the direction of the workpiece feed to the circular saw.

19. A device according to one of claims 17 and 18 characterized in that the positively locking engagement is formed by a dovetail profile.

20. A device according to one of claims 17 to 19 characterized in that the positively locking engagement has a positively locking, releasable securing lock.

21. A device according to one of claims 17 to 20 characterized in that a handle is integrated in a front edge of the guard hood, which is directed in the direction of the workpiece feed to the circular saw.

22. A device according to one of claims 17 to 21 characterized in that the guard hood is supported on the arm adjustably in respect of height in a linear guide.

23. A device according to claim 22 characterized in that the guard hood is biased upwardly by means of a spring in the linear guide to compensate for its inherent weight.

24. A device according to one of claims 22 and 23 characterized by a brake which brakes the movement of the guard hood in the linear guide.

25. A device according to claim 24 characterized in that the brake is adjustable and involves frictional engagement.

26. A device according to one of claims 22 to 25 characterized in that in the region of the workpiece feed in front of the saw blade the guard hood has a guide profile which urges the guard hood upwardly by a fed workpiece, and that the linear guide is tilted out of the vertical away from the region of the workpiece feed in the plane of the saw blade.

27. A device according to claim 26 characterized in that the guide profile is formed by a roller which forms the front lower edge of the underside opening of the hood.

28. A device according to one of claims 17 to 27 characterized by a motor which drives the heightwise adjustment of the guard hood.

29. A device according to claim 28 characterized by control of the motor with a sensor which monitors the region of the workpiece feed in front of the saw blade and which delivers a signal to the control means upon the presence of an object in said region.

30. A device according to claim 29 characterized in that the sensor is a video camera.
